(19) United States
(12) Patent Application Publication
(10) Pub. No.: US 2017/0356483 A1
(43) Pub. Date: Dec. 14, 2017

(54) COLD-WORKED RIVETED PISTON/ROD ASSEMBLY AND METHOD OF MAKING SAME

(71) Applicant: LIPPERT COMPONENTS, INC., Elkhart, IN (US)

(72) Inventor: Nicholas CORNETT, Granger, IN (US)

(21) Appl. No.: 15/623,023

(22) Filed: Jun. 14, 2017

Related U.S. Application Data
(60) Provisional application No. 62/349,971, filed on Jun. 14, 2016.

(51) Int. Cl. F16B 19/08; F16J 1/12; F04B 1/12; B21J 15/10

(52) U.S. Cl. CPC F16B 19/08; F04B 1/124; F16J 1/12; B21J 15/10

(57) ABSTRACT

A piston and piston rod assembly includes a piston rod having a first portion and a smaller second portion extending from the first portion. The second portion has a circumferential groove that receives at least one sealing ring or O-ring located between the first portion and the free end of the second portion. A piston has an aperture extending between two ends, with the top open end having a larger diameter than the bottom open end. The second portion of the piston rod is inserted through the aperture of the piston so that the free end of the second portion emerges through the top open end of the piston and compresses the at least one sealing ring or O-ring with the inner surface of the piston. The free end of the second portion of the piston rod is cold-worked to overlie at least a portion of the top open end of the piston.

### CROSS-REFERENCE TO RELATED APPLICATION

This application claims benefit under 35 U.S.C. §119 of U.S. Provisional Patent Application No. 62/349,971, filed on Jun. 14, 2017, and incorporates by reference the disclosure thereof in its entirety.

### BACKGROUND OF THE DISCLOSURE

Hydraulic and pneumatic actuators typically include a cylinder and a piston and piston rod assembly displaceable within the cylinder. The piston and piston rod typically are formed separately and then connected together. For example, the piston rod may be formed with a threaded end, and the piston may be formed with a threaded receptacle opposite its working face. The piston rod and piston may be joined by threading the threaded end of the piston rod into the threaded receptacle of the piston. This assembly method, however, is imperfect in that the piston and piston rod may become unthreaded and disconnected during use, thereby rendering the actuator unusable.

Alternatively, the piston rod may be formed with a deformable end and the piston may be formed with a hole extending through its face for receiving the deformable end of the piston rod. The piston and piston rod may be joined by inserting the deformable end of the piston rod through the hole in the piston and peening the end of the deformable end of the piston rod into secure engagement with the piston. This method of assembly also is imperfect in that some form of seal is required between the piston rod/piston interface to preclude working fluid from bypassing the piston while the actuator is in use and further because the working face of the piston is prone to damage during the peening process.

### BRIEF DESCRIPTION OF THE DRAWINGS

FIG. 1 is a perspective view of a piston and piston rod assembly according to the present disclosure;

FIG. 2 is a side view of the piston and piston rod assembly of FIG. 1;

FIG. 3 is a perspective view of an end of the piston rod of FIG. 1;

FIGS. 4A-4D are views of the piston and piston rod assembly of FIG. 1 showing details thereof;

FIGS. 5A-5C are views of the piston rod of FIG. 1 showing details thereof;

FIGS. 6A-6C are drawings of the piston of FIG. 1 showing details thereof;

FIG. 7 is a perspective cutaway view of the piston and piston rod assembly of FIG. 1; and

FIG. 8 is a perspective view of the piston of FIG. 1 assembled to the piston rod of FIG. 1 and installed in an orbital riveting machine prior to a peening operation that secures the piston to the piston rod.

### DETAILED DESCRIPTION OF THE DRAWINGS

The drawings show an illustrative embodiment of a piston and piston rod assembly 20 including a piston 22 and a piston rod 24 according to the present disclosure. The piston rod 24 is shown as stepped cylindrical, having a first (or main) portion 26 of a first diameter and a second (or protruding) portion 28 of a second diameter lesser than the first diameter. In other embodiments, the main portion 26 and the protruding portion 28 may have forms other than cylindrical. For example, the main portion 26 and the protruding portion 28 may have rectangular, oval, or other cross sections. In such embodiments, the cross-sectional area of the main portion 26 typically would completely or at least partially bound or overlap the cross-section of the protruding portion 28. The piston rod 24 may be made of aluminum or another material such as steel, plastic, or another material capable of being selectively plastically deformed, as discussed further below, and able to withstand the stresses to which the piston rod may be subjected in use. The piston rod 24 may be formed in any suitable manner For example, the piston rod 24 may be machined from solid bar stock.

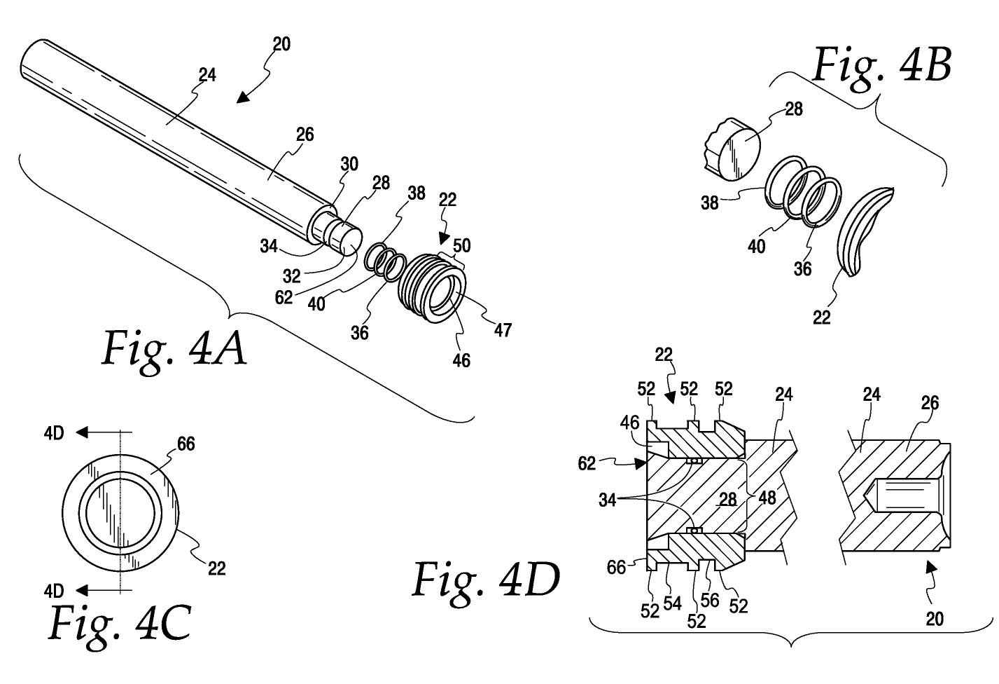

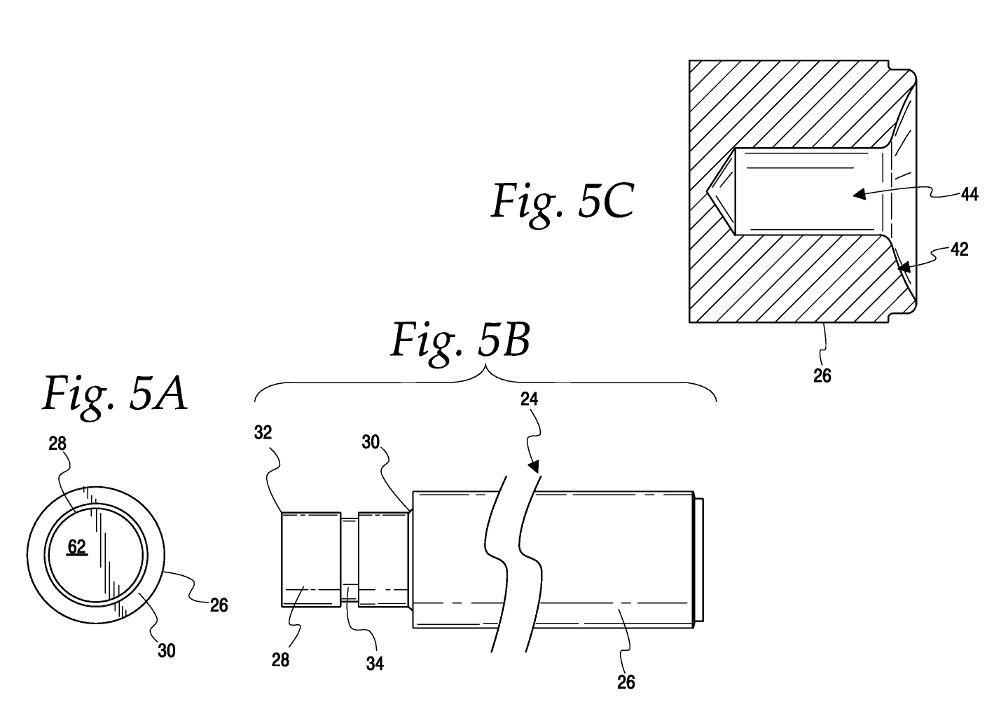

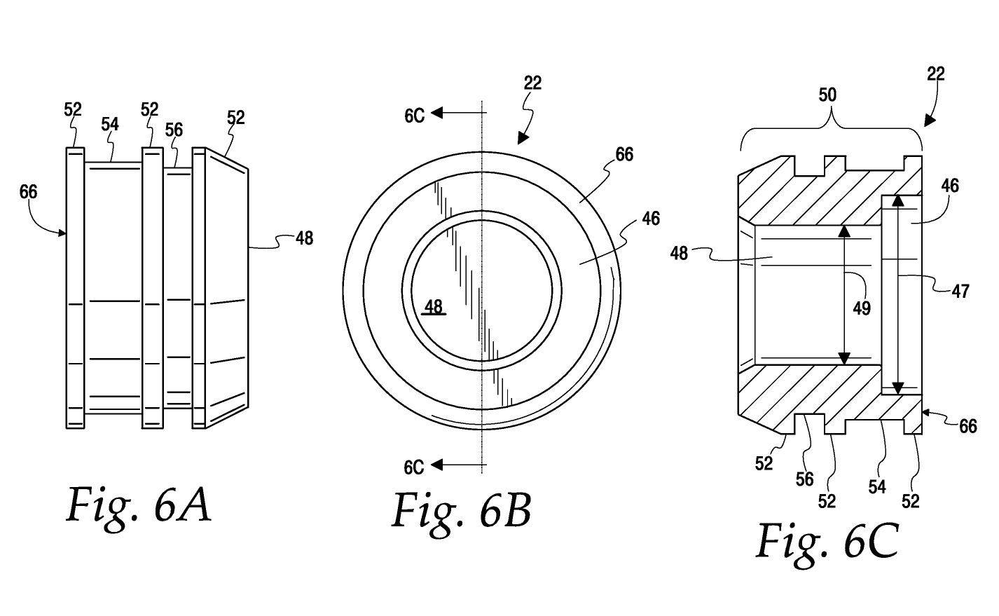

As best shown in FIGS. 4A and 5B, the protruding portion 28 extends from the main portion 26 and is concentric therewith. A ledge (or land) 30 is defined by the exposed end surface of the main portion 26 at the junction of the main portion 26 and the protruding portion 28, as shown in FIGS. 6A and 6B. The protruding portion 28 has a free end 32 opposite the end thereof connected to the main portion 26. In addition, the protruding portion 28 defines a circumferential groove 34 extending inwardly from the periphery of the cylindrical body of the protruding portion 28, as best shown in FIG. 5B. The groove 34 may house one or more seal rings 40, for example O-rings, and one or more optional back-up rings 36, 38 adjacent the seal ring. For example, the seal ring 40 may be sandwiched between a pair of back-up rings 36, 38. The back-up rings 36, 38 or one of them may have a convex surface facing the seal ring 40. This arrangement of seal ring 40 and back-up rings 36, 38 may mitigate or preclude working fluid from leaking past the interface between the protruding portion 28 and the piston 22, as will become evident from the discussion below. Such leakage could adversely affect the ability of an actuator including the piston and piston rod assembly 20 to retain pressure in a working chamber of the actuator and could thereby adversely affect the actuator's operating efficiency.

As shown in FIG. 4, the main portion 26 of the piston rod 24 includes a free end having a surface 42. The surface 42 may be concave, as best shown in FIG. 5D. The surface 42 and the main portion 26 may cooperate to define a hole 44 for receiving an end of a foot pad (not shown). The hole 44 may be internally threaded, as shown in FIG. 6D.

As shown in FIGS. 4C, 6A-6C, and 7, the piston 22 may have a generally annular body having a first end 46 and a second end 48 and defining a bore 50 extending there through from the first end to the second end. In other embodiments, the piston could be a body of another suitable shape or cross-section having a first end and a second end and defining a bore extending there through from the first end to the second end. The bore 50 of the piston 22 may be of a single continuous diameter from the first end to the second end. Alternatively, as shown, the bore 50 may have a first diameter over at least a central portion of its length and define a counter bore 47 extending inwardly from the first end 46 of the piston 22 and/or a countersink 49 extending inwardly from the second end 48 of the piston. The counter bore 47 may have a second diameter greater than the first diameter of the bore 50, and the counter sink 49 may have a major diameter greater than the first diameter of the bore 50.

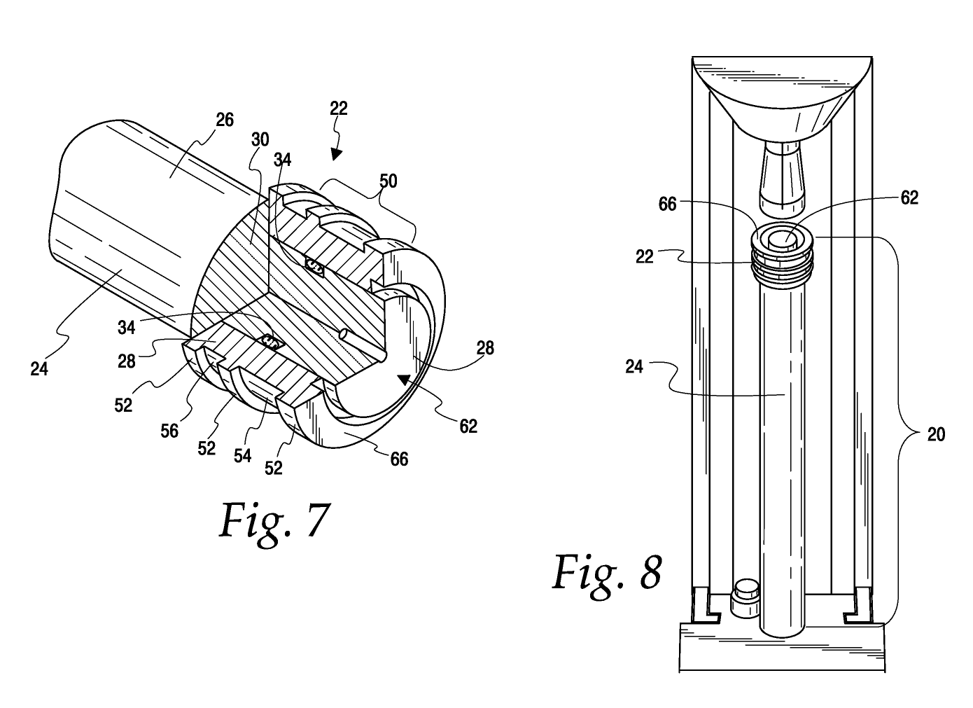

In any event, the bore 50 is sized to slidingly receive the protruding portion 28 of the piston rod 24 through the piston 22 without excessive lateral play. The bore 50 also is sized to slidingly receive the protruding portion 28 of the piston rod 24 and the seal ring 40 (and the back-up rings 46, 48, if provided) within the groove 34 of the protruding portion and sufficiently compress or otherwise engage the seal ring to effect a seal between the piston 22 and the piston rod 24, as best shown in FIGS. 4D and 7.

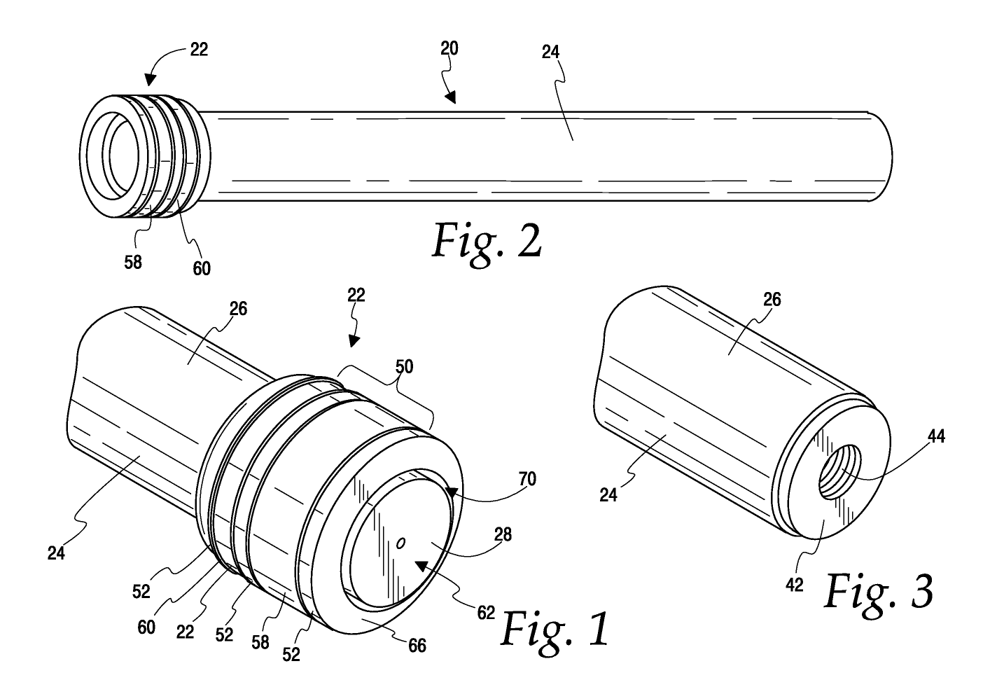

As best shown in FIGS. 6C and 7, the exterior circumferential surface of the piston 22 defines first and second circumferential ring grooves, 54, 56. The ring grooves 54, 56 are configured to receive respective piston rings, for example, at least one wear ring 58 and one seal ring 60. As best shown in FIGS. 1 and 2, a wear ring 58 may be received in the first ring groove 54 and a seal ring 60 may be received in the second ring groove 56. The seal ring 60 may be provided to block transmission or leakage of working fluid across the interface between the piston 22 and a corresponding cylinder (not shown). The wear ring 58 may be provided to mitigate or reduce wear on the piston and/or the corresponding cylinder. In other embodiments, the positions of the seal and wear rings could be reversed. Other embodiments could include more or fewer ring grooves and corresponding piston rings.

In the illustrated embodiment, the exterior circumferential surface of the piston 22 is tapered inwardly proximate the second end 48 of the piston. In other embodiments, the exterior circumferential surface of the piston could be right cylindrical (except for the regions defining the piston ring grooves).

As shown in FIG. 8, the protruding portion 28 and the piston 22 are configured so that the free end 32 of the protruding portion may extend beyond the end of the bore 50 proximate the first end of the piston when the protruding portion is fully inserted in the piston from the second end 48 of the piston, that is, when the ledge 30 abuts the second end of the piston. With the piston 22 and the piston rod 24 so assembled, the free end 32 of the protruding portion 28 of the piston rod 24 may be cold-worked to form a head of a rivet, thereby securing the piston to the piston rod. More specifically, the free end 32 of the protruding portion 28 of the piston rod 24 may be flattened or otherwise deformed to form a lip 64 that is larger in diameter than the diameter of the bore 50 at the first end 46 of the piston 22 to thereby secure the piston to the piston rod. The securement may be, but need not be, sufficient to eliminate play between the piston 22 and piston rod 24 and/or preclude rotation of the piston relative to the piston rod.

The cold-working may be performed using any suitable process, for example, orbital riveting, peening, crushing, or another process that deforms the free end 32 of the protruding portion 28. For example, FIG. 8 shows the unworked piston 22 and piston rod 24 assembly installed in an orbital riveting machine. The orbital riveting machine may be used to perform an orbital riveting process on the free end 32 of the protruding portion 28 of the piston rod of the unworked assembly, the orbital riveting process flattening or otherwise deforming the free end of the protruding portion to form a lip 64 that is larger in diameter than the diameter of the bore 50 at the first end 46 of the piston 22, thereby securing the piston to the piston rod.

The free end 32 of the protruding portion 28 of the piston rod 24 may be cold worked to be recessed from, flush with, or proud of a top rim 66 of the piston 22. The free end 32 of the protruding portion 28 of the piston rod 24 may be cold worked to yield a substantially continuous and planar surface.

In any event, the bore 50 and counter bore 47 of the piston 22 and the protruding portion 28 of the piston rod 24 may be sized so that the cold working process can be accomplished without the cold working tool or the lip 64 coming into contact with either the face of the piston 22 or the inner wall of the counter bore 47. For example, as shown in FIG. 1, the inner wall of the counter bore 47 defined by the top rim 66 of the piston 22 and the lip 64 resulting from cold working the protruding portion 28 cooperate to define a groove 70 there between.

The embodiment shown in the drawings is illustrative and not limiting. The scope of the invention is defined only by the claims below.

1. A method of making a piston and piston rod assembly, comprising the steps of:
providing a piston having first end and a second end, the piston defining a bore extending axially therethrough from the first end to the second end, the piston further defining a counter bore concentric with the bore and extending axially inwardly from the first end of the piston;
providing a piston rod including first portion having a first diameter and a free end, and a second portion having a second diameter and a free end, the second diameter lesser then the first diameter;
inserting the second portion of the piston rod into the bore so that the free end of the second portion of the piston rod extends outwardly from the bore of the piston; and
cold working the free end of the second portion of the piston rod so that the piston becomes secured to the piston rod.

2. The method of claim 1, wherein the step of cold-working comprises cold-working the free end of the second portion of the piston rod so that no portion thereof is proud of the first end of the piston.

3. The method of claim 1, wherein the step of cold-working comprises cold-working the free end of the second portion of the piston rod so that no portion thereof contacts a side wall surface of the counter bore.

4. The method of claim 1, the piston further defining a countersink extending axially inwardly from the second end thereof.

5. The method of claim 1, the second portion of the piston rod defining a circumferential groove, the method further comprising the steps of providing a seal ring and disposing the seal ring in the groove.

6. The method of claim 1 wherein the step of cold working comprises orbital riveting.

7. The method of claim 1 wherein the step of cold working comprises cold-working the free end of the second portion of the piston rod to yield a substantially continuous planar surface.

8. The method of claim 1 wherein the step of cold working comprises cold-working the free end of the second portion of the piston rod so that the piston becomes secured to the piston rod with no play therebetween.

9. The method of claim 1 wherein the free end of the first portion of the piston rod defines a hole.

10. The method of claim 1 where the piston rod defines a land at an interface between the first portion of the piston rod and the second portion of the piston rod and wherein the piston abuts the land in compressive engagement.

11. An assembly comprising:
a piston having first end and a second end, the piston defining a bore extending axially therethrough from the first end to the second end, the piston further defining a counter bore concentric with the bore and extending axially inwardly from the first end of the piston; and
a piston rod including first portion having a first diameter and a free end, and a second portion having a second diameter and a free end, the second diameter lesser then the first diameter;
wherein the second portion of the piston rod is received in the bore so that the free end of the second portion of the piston rod extends outwardly from the bore of the piston; and
wherein the free end of the second portion of the piston rod is deformed and thereby secures the piston to the piston rod.

12. The assembly of claim 11, wherein no portion of the free end of the second portion of the piston rod is proud of the first end of the piston.

13. The assembly of claim 11, wherein no portion of the free end of the second portion of the piston rod contacts a side wall surface of the counter bore.

14. The assembly of claim 11, the piston further defining a countersink extending axially inwardly from the second end thereof.

15. The assembly of claim 11, the second portion of the piston rod defining a circumferential groove, the assembly further comprising a seal ring disposed in the groove.

16. The assembly of claim 11 wherein the free end of the second portion of the piston rod has a substantially continuous planar surface.

17. The assembly of claim 11 wherein the free end of the second portion of the piston rod is secured to the piston rod with no play therebetween.

18. The assembly of claim 11 wherein the free end of the first portion of the piston rod defines a hole.

19. The assembly of claim 11 where the piston rod defines a land at an interface between the first portion of the piston rod and the second portion of the piston rod and wherein the piston abuts the land in compressive engagement.
